(19) United States
(12) Patent Application Publication
(10) Pub. No.: US 2005/0128756 A1
(43) Pub. Date: Jun. 16, 2005

(54) Outdoor decorative lighting housing

(76) Inventor: Deborah Prine, Akron, OH (US)

Correspondence Address: HAHN LOESER & PARKS, LLP, One GOJO Plaza, Suite 300, AKRON, OH, 44311-1076, US

(21) Appl. No.: 11/009,998

(22) Filed: Dec. 11, 2004

Related U.S. Application Data
(60) Provisional application No. 60/528,863, filed on Dec. 12, 2003.

(51) Int. Cl. F21V 21/00

(52) U.S. Cl. 362/382

(57) ABSTRACT

The present invention relates to a housing unit, particularly a modular housing unit, for use in association with outdoor decorative lighting. The housing unit provides method of permanently attaching decorative lights to a building structure. A switch allows the user to remotely operate the lighting display for a variety of functions including switching the lights between different colors; to change the lighting pattern; and/or to control movement of the housing from a stowed to an operative position. When the decorative lights are in a stowed position, the housing is designed to compliment or blend into the building structure, such that the housing is not noticeable. The housing is movable about a hinge or other means such that the decorative lights can be placed in an operative position. In the operative position the lights are viewable through a transparent window. The housing features modular connections such that multiple housing units may be connected together. A rotation means such as a motor may be attached to move the housing units from a stowed to an operative position. The invention finds particular use in association with outdoor holiday lighting, as is commonly used at Christmas and, more commonly in recent years, Halloween.

### PRIORITY

This application claims the benefit of U.S. Provisional Application No. 60/528,863 filed Dec. 11, 2003. Application Ser. No. 60/528,863 is hereby incorporated by reference.

### TECHNICAL FIELD

The present invention relates to a housing unit, particularly a modular housing unit, for use in association with outdoor decorative lighting. The invention finds particular use in association with outdoor holiday lighting, as is commonly used at Christmas and, more commonly in recent years, Halloween.

### BACKGROUND OF THE ART

It has become a tradition in many communities to celebrate holidays, such as Christmas and Halloween, by stringing outdoor decorative lighting. In some cases, the lighting has individual bulbs of a various colors, and in other cases, the lighting has individual bulbs of a single color or of colors particular to the holiday, such as red and green at Christmas or orange at Halloween.

In colder climates, the lights are strung around the eaves of the house before the holiday season actually starts, so that the lights are in place prior to the onset of snow and freezing temperatures. Afterward, the winter conditions in many locales prevent the lighting from being removed immediately after the holiday.

In other climates, it may be desirable to protect the lighting from other weather, such as wind and rain.

When lighting is used for multiple seasons, it is generally necessary to either re-string different lighting or to replace the individual bulbs if the same wiring is used.

It is an object of the invention to provide a housing system for the outdoor decorative lighting, so that the lighting can be more permanently mounted on the house, but can be moved from a lowered or operative position to a stowed or protective position when desired.

### SUMMARY OF THE INVENTION

The modular outdoor holiday lighting device, as described in more detail below, achieves this and other objects of the present invention.

### BRIEF DESCRIPTION OF THE DRAWINGS

The present invention will be better understood when reference is made to the accompanying drawings, wherein identical parts are identified with identical reference numerals, and wherein:

FIG. 1 shows the box-like body of the housing unit of the present invention in perspective view.

FIG. 2 shows a front elevation view of the housing unit of the present invention.

FIG. 3 shows a side elevation view of the housing unit of the present invention.

FIG. 4 shows a plurality of the housing units of the present invention in front elevation view.

FIGS. 5a and 5b show, in side elevation view, an embodiment of the present invention in operative and stowed positions, respectively.

FIGS. 6a and 6b show, in side elevation view, an embodiment of the present invention in operative and stowed positions, respectively.

FIG. 7a thru 7d show, in front and side elevation views, a further embodiment of the present invention.

FIG. 8 shows a top view of an alternate embodiment of the present invention.

### DETAILED DESCRIPTION OF A PREFERRED EMBODIMENT

Shown in perspective view in FIG. 1 is a box-like body 12 of the housing unit 10 of the present invention with a rear wall 14, left and right side walls 16, 18, and top and bottom walls 20, 22. In the embodiment shown, the top and bottom walls 20, 22 are preferably adapted to allow a removable front wall 24 (not shown in this view) to be positioned onto the housing unit 10, effectively providing a closed unit, preferably having a water-tight seal. In other cases, it is possible to make the rear wall 14 removable, to allow access to a body 12 in which the front wall 24 is integral with the sidewalls 16, 18 and top and bottom walls 20, 22. In either case, access to the interior of the body 12 is provided through the rear or front wall 14, 24. While the box-like body 12 is preferably constructed from a plastic material, it may be formed from any sheet metal, typically of a light gauge, or other suitable material. The removable front wall 24 will almost inevitably be plastic, particularly a translucent plastic, such as a polymethyl methacrylate, such as is sold commercially as PLEXIGLAS. In some circumstances the front wall 24 may be glass.

In the preferred embodiment, the box-like body 12 has rectangular walls 14, 16, 18, 20, 22, 24 that define an interior cavity or chamber 26 in which conventional holiday decorative lighting may be positioned. The body 12 has a length L, extending from the left to the right side wall, a height H, extending from the top to the bottom wall and a depth D, extending from the front to the rear wall. In the preferred embodiments, the length will be several times larger than the height and the height will be larger than the depth.

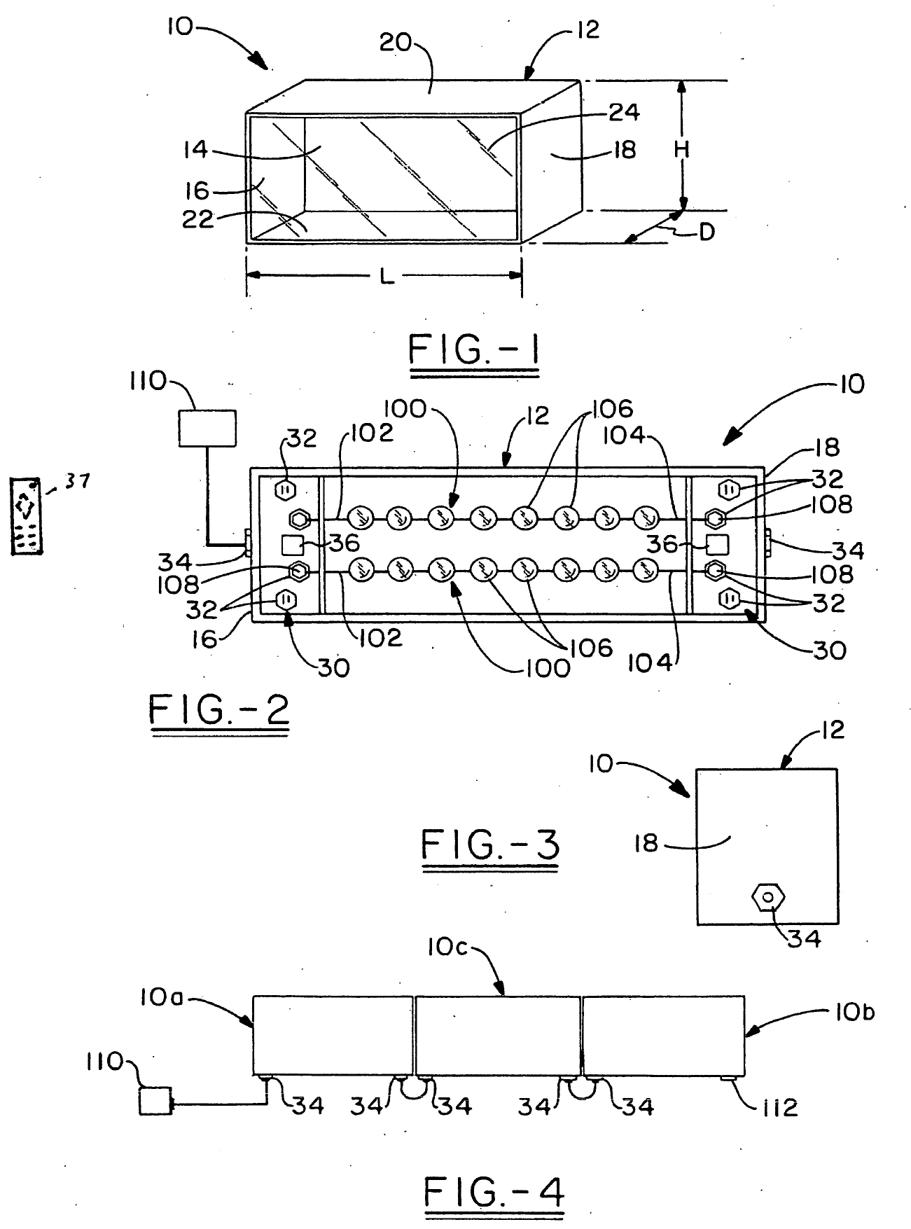

As shown in front elevation view in FIG. 2, the housing unit 10 may accommodate one, two, or multiple strings of holiday lights 100. Such a string of holiday lights 100 will extend from near one sidewall to near the other sidewall. The string of holiday lights 100 may be particular to the invention or the intention may allow use of commercially available holiday light strings. The strings of holiday lights may also comprise one or more rows of light emitting diodes (LEDs).

To be compatible with the invention as anticipated, a string of holiday lights 100 should have a first and a second end 102, 104, with a plurality of lights 106 connected in a closable electrical circuit (either in series or in parallel) along a length of the string as shown in FIG. 2. Each of the ends 102, 104 should have a plug or connector 108 for electrically communicating the string of lights 100 to another such string. The connectors may be standard or may be of a proprietary design, such as the “quick connect” mating, two-pronged plug and receptacle connectors available from Sunbeam Corporation in its string lighting products. These lights have a two-pronged plug at one end with a receptacle on top of the plug. The string of lights also has a receptacle at the opposite end. This arrangement allows a plurality of holiday light strings 100 within housing units 10 to be electrically connected together.

In the preferred embodiment of the invention, the box-like body 12 will be adapted at or near the left and right side walls 16, 18 to receive a connection unit 30, particularly a modular connection unit that may be “plugged into” the body 12 to provide means for connecting strings of holiday lights 100 in a particular body to either an external power source 110 or another string of holiday lights in an adjacent body. For that reason, the connection unit 30 will provide a plurality of connectors 32, each connector 32 being capable of receiving an end connector 108 of a string of holiday lights. The connectors 32 may be either a two-pronged plug or a two-slot receptacle for receiving an end of the holiday light strings 100. A corresponding number of connectors 32 should be available at each side 16, 18 of the body 12. A typical number of connectors 32 with each connection unit 30 will be four. By way of illustration only, this would allow up to 4 strings of lights to be connected in the unit shown in FIG. 2. In an embodiment of the connection unit 30, each connector 32 will be directly communicated to an external connector 34 that is located in one of the sidewalls 16, 18 or the rear wall 14.

The connection unit 30 may also contain a switching means 36 in the communication between connector 32 and external connector 34, so that the number of external connectors 34 can be less than the number of connectors 32. External connector 34, mounted on right side wall 18, is shown in side elevation view in FIG. 3. Such switching means 36 is well within the knowledge of one of ordinary skill in this art. By this means, it is possible to direct external power, from a single conventional alternating current source, for example, to any of a number of holiday light strings 100 arrayed in a given body 12. The switch 36 could allow the user to select the string of holiday lights 100 available for viewing. For example, the user could switch from orange Halloween lights to green and red Christmas lights, between seasons. Other strings of lights could be used for other occasions.

The switching means 36 may also have other features. For example, it may have an infrared or radio frequency receiver such that a handheld remote control device 37 can operate the lights within the housing unit 10. Such remote operation means are well known in the art such as the device taught by Xydis et al. in U.S. Pat. No. 6,252,358. The switching means 36 may also contain solid state circuitry that would allow it to detect when one string of holiday lights 100 is not functional, allowing the second string of holiday lights to be switched on. The circuitry could also be used generate decorative patterns among the strings of lights positioned with in the housing unit 10. Switching means 36 could also sequence the lighting patterns among lights within multiple connected housing units 10. The switching means may comprise a master switch 36, disposed within one of said housing units 10 for controlling all other switching means 36 within the housing units 10. Such light sequencing devices are well known in the art such as the device taught by Puleo, et al. in U.S. Pat. No. 6,653,797. Finally, the switching means may contain solid-state circuitry to drive one or more rows of LEDs. The circuitry could have the ability to select the colors of the LEDs to be display for the appropriate holiday season.

In most embodiments of the invention, it is expected that at least two units 10 will be connected together to form the complete lighting unit. In such an embodiment, as shown in front view in FIG. 4, there will be a first end unit 10a, a second end unit 10b, and there may be at least one intermediate unit 10c. In such an arrangement, the first end unit 10a will connect at a first side at one of the external connectors 34, shown positioned on the bottom wall 22, to the external power source 110 and at a second side to an adjacent unit, 10b or 10c. At the other end of the arrangement, the second end unit 10b will be connected at a first end through the external adjacent unit. Because of this, it may be necessary that the second end of the second end unit 10b to plug an end connector 112 into external connector 34 in order to complete the electrical circuit. In other situations, the absence of a connection to the external connector 34 in one of the connection units 30 may serve to provide a default completion of the circuit, which is over-ridden by the insertion of a connection. As with the other electrical circuitry in this invention, those of ordinary skill in electrical wiring will understand how to make the appropriate connections.

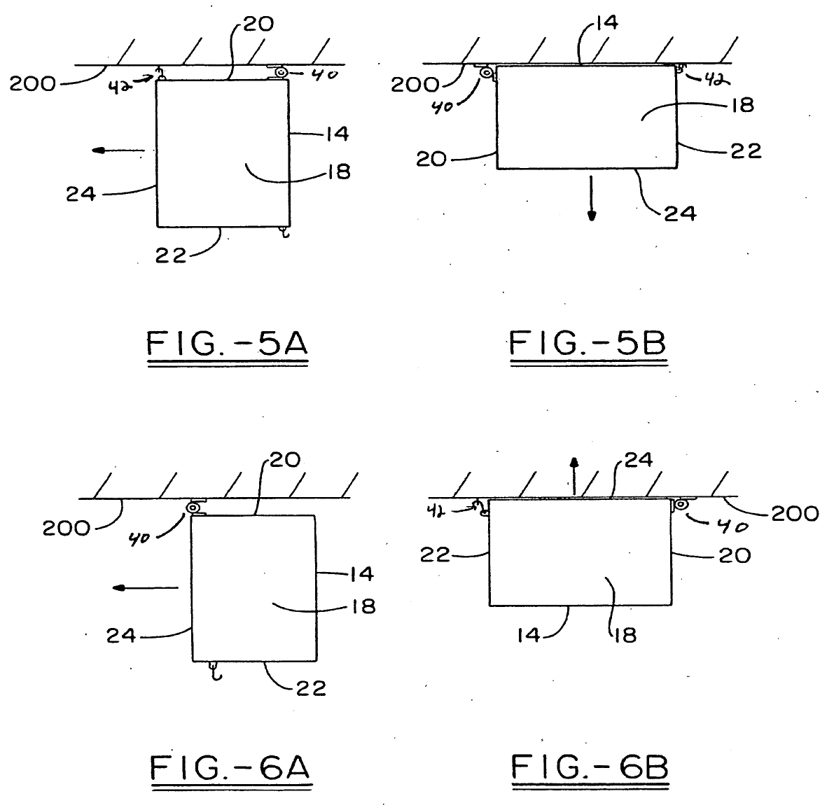

In a further feature of the invention, illustrated in FIGS. 5 thru 7, each housing unit 10 will be provided with means for moving the housing unit from a lowered or operative position to a stowed or protective position when desired. When the housing unit is in a stowed position, the front wall 24 does not face outward and thus, the lights are not visible. While in the stowed position, the wall that is outward facing can be designed or painted to match the exterior of the house or building so that it blends in.

FIGS. 5 and 6 illustrate how a hinge means 40 can attach to each housing unit 10. The hinge means is also attached to the mounting structure 200, such as the lower surface of the eaves or over hangs of a house. By way of illustration in FIG. 5, the hinge means 40 is positioned along the line of intersection of the top and rear walls 20, 14. In such an embodiment, the top wall 20 faces outwardly and the front wall 24 faces down when the unit 10 is in the stowed position and held in place by the latch 42. A pole or broom handle may be used to abut and slightly push upwards on the housing unit 10, activating a spring loaded quick release or compression latch 42. When the unit 10 is rotated 90° clockwise about the hinge means, the top wall will face upwardly and the front wall will face outwardly in the operative position, such that the lights can be seen.

In another possible mounting, FIG. 6, the hinge means 40 is positioned at the line of intersection of the top and front walls 20, 24. In such an embodiment, the bottom wall 22 will face outwardly and the front wall 24 will face upwardly when the unit 10 is in the stowed position and held in place by the latch 42. When the unit 10 is rotated 90° counterclockwise about the hinge means, the front wall will face outwardly and the bottom wall will face downwardly in the operative position.

It will be readily observed that the placement of the external connectors 34 on the housing unit 10 may be strongly influenced by the placement of the hinge means 40, to facilitate access to the connectors 34.

At least one stop or latch means 42 may be used to retain each unit 10 in either the stowed or operative position. The stop or latch may be a spring loaded, magnetic quick release or compression latch that is well known in the art. In other embodiments, the movement between the two positions may be achieved by a motor or rotation means 44, in which case the motor may provide the stop means.

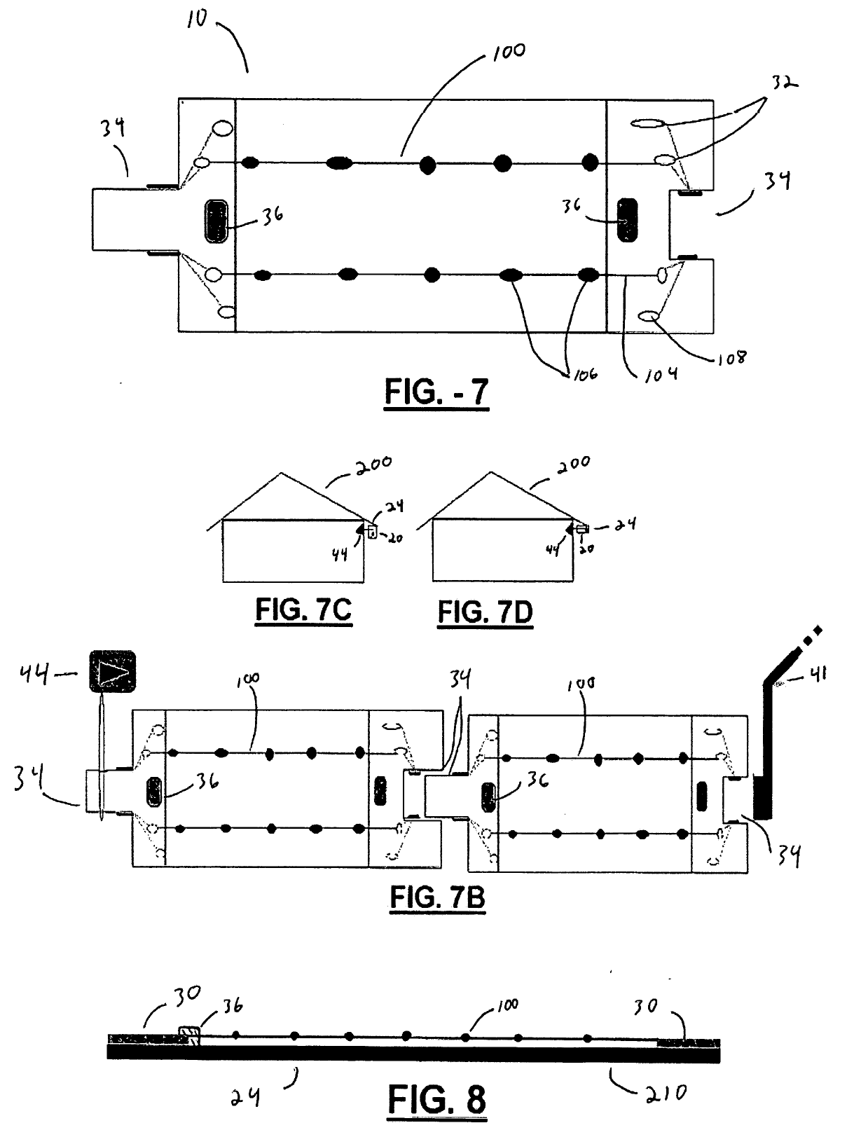

In still another version shown in FIG. 7, the external connector 34 is a protrusion at one side of the housing 10 and a complimentary, mating recess at the opposite side. The external connectors 34 have electrical contacts on their mating surfaces that connect with the switching means 36 and either an external power source 110, a second housing unit 10 or both. The complimentary protruding and recess external connectors 34 allow a plurality of housing units 10 to be fixedly connected to one another as shown in FIG. 7a.

The external connector 34, allows multiple housing units 10 to be rigidly connected together in a modular fashion such that they can be rotated simultaneously along the same axis of rotation as shown in FIG. 7B. Alternatively, the external connector could be a rigid shaft extending between one or more housing units 10 and providing electrical connections therein. Multiple housing units 10 may attach together via the external connectors 34, providing one continuous rigid body. Support means 41 may be attached to the mounting structure 200 to support the entire rigid body of connected housing units 10. The support means 41 may allow rotation of the housing units 10 from stowed to operative positions and vice versa. The external connectors 34 allows multiple housing units 10 to be rotated simultaneously, so that the housing units can me moved from an operative to a stowed position and vice versa as shown in FIGS. 7C and 7D. For example, when the housing units 10 mounted under the eaves of a house, the top wall 20 will face outward and the front wall 24 will face upward when the housing units 10 are in a stowed position as shown in FIG. 7C. The housing units 10 can be rotated 90° counterclockwise about the support means 41 to reach the operative position, FIG. 7D. In the operative position the front wall 24 will face outwardly and the top wall 20 will face downward.

A rotation means 44, such as an electrical motor may be mounted on the mounting structure 200 and connected to an external connector 34 for rotating one or a plurality of housing units 10 about the axis. The switching means 36 may be in electrical connection to the rotation means 44, to allow the housing units 10 to move from an operative to a stowed position and vice versa. A master switching means 36 may operate via the remote control device 37 to initiate movement of several connected housing units 10.

The external connector 34 may be fixedly or rotatably attached to the housing units 10. A rotation means 44 may be disposed within each housing unit 10. This rotation means may allow each housing unit to rotate along its internal external connector tube shaft 34 individually. The remote control device 37 may be used to separately operate each individual housing unit 10. This would allow each housing unit 10 to be individually moved from a stowed to operative position and vice versa.

It will be readily understood that each of these stowage positions has advantages and disadvantages. A primary advantage of the first stowage position is that the front wall is easily accessed, providing access to the interior chamber 26, when the housing unit 10 is stowed. A primary advantage of the second stowage position is that the front wall is stowed upwardly, which provides an additional modicum of protection to it, particularly in embodiments when it is the only plastic or glass wall of the body 12.

While FIG. 2 shows the embodiment 10 where the connection units 30 are mounted inside the housing unit 12 and the front wall 24 covers the box-like housing unit, an alternate embodiment 210 of the present invention is shown in FIG. 8. In this version, the connection units 30 are mounted on a surface of the front wall 24 and the strings of holiday lights are strung from one connection unit to the other. Here, the lights are not sealed in a box and allowed to remain exposed to the elements. This less expensive design allows the lights to be quickly mounted and controlled via the remote controlled switching means.

While the preferred embodiments have been described above, it is understood that various modifications can be made to the exact form of the present invention without departing from the scope thereof. It is accordingly intended that the disclosure be take as illustrative only and not limiting in scope, and that the scope of the invention be defined by the following claims:

1. A protective display for decorative light strings, comprising:
a housing having a plurality of walls that form an exterior surface and an enclosed interior cavity therein, at least one wall being transparent and at least one wall being selectively movable to provide access to the cavity, the housing including at least one pair of electrical connections in the cavity, wherein a first member of each pair is adapted to connect to an external power source, and a second member of each pair is adapted to connect to a second protective housing;
at least one light string positioned within said cavity, the light string being connected between both members of the pair of electrical connections;
a hinge attached to the exterior surface of the housing, wherein, the housing is movable about the hinge between a first operative position to a second stowed position.

2. The protective display according to claim 1, wherein the at least one light string comprises conventional holiday decorative lights.

3. The protective display according to claim 1, wherein the protective housing includes multiple light strings.

4. The protective display according to claim 1, wherein one member of each pair of electrical connections comprises a grooved connection, the other member of each pair of electrical conntections comprises a pronged connection.

5. The protective display according to claim 1, further comprising a spring loaded magnetic latch for releasably holding the protective display in the stowed position.

6. A protective display for decorative light strings, comprising:
a housing having a plurality of walls that form an exterior surface and an enclosed interior cavity therein, a transparent portion for viewing the contents inside the cavity, and a moveable portion for accessing the cavity,;
at least one pair of electrical connections in the cavity, wherein a first member of each pair is adapted to receive power from an external source, and a second member of each pair is adapted to electrically connect to a second protective housing;
at least one light string positioned within said cavity, the light string being connected between both members of the pair of electrical connections;
a switch operably connected to the pair of electrical connections, the switch controlling operation of the light strings;
a hinge attached to the exterior surface of the housing, wherein,
the housing is movable about the hinge between a first operative position to a second stowed position.

7. The protective diaplay according to claim 6, wherein the switch allows remote operation of the light strings via a remote control.

8. A protective display according to claim 6, wherein the switch alternatively switches power between the light strings.

9. A protective display according to claim 6, wherein the display is electrically connected to a second protective display having a second light string therein, the switch controlling the light strings in both protective displays.

10. A protective display according to claim 6, wherein the housing includes a plurality of light strings, and the switch produces pre-programmed lighting patterns among the light strings.

11. A protective display according to claim 6, wherein the light string is comprised of one or more rows of light emitting diodes.

12. A protective display according to claim 6, wherein the housing is waterproof.

13. A modular protective display for decorative light strings, comprising:
an enclosure having an interior cavity, a left wall, a right wall, a transparent portion for viewing the contents inside the cavity, and a moveable portion for accessing the cavity, the left wall and the right wall each having a coupler, one of the couplers comprising a protrusion, the other of the couplers comprising a recess of similar size and shape to the protrusion;
at least one pair of electrical connections within the cavity, one member of the at least one pair being electrically connected to the recess, the other member of the at least one pair being electrically connected to the protrusion;
at least one light string positioned within the cavity, the light string being connected between both members of the pair of electrical connections.

14. In combination:
a first protective display as recited in claim 13;
a second protective display as recited in claim 13; wherein,
the protrusion of the first protective display is removably retained within the recess in the second protective display, forming a physical and electrical connection between the first protective display and the second protective display.

15. The combination according to claim 14, wherein the assembly has an axis of rotation about a line formed through the couplers, and wherein the assembly further comprises means for rotating the assembly between an operative position and a stowed position.

16. The combination according to claim 15, wherein:
the means for rotating the assembly is attached to one of the couplers.

17. The combination according to claim 15, further comprising:
a switch for controlling the means for rotating the assembly.

18. The combination according to claim 17 further comprising:
a remote control that operates the switch.

19. The display according to claim 13, wherein,
at least a portion of the housing is paintable.

20. The display according to claim 13, wherein:
the at least one light string comprised of one or more rows of light emitting diodes.
